(19) United States
(12) Patent Application Publication
(10) Pub. No.: US 2007/0077410 A1
(43) Pub. Date: Apr. 5, 2007

(54) Plastic films

(76) Inventor: Guangda Shi, Evansville, IN (US)

Correspondence Address: CANTOR COLBURN, LLP, 55 GRIFFIN ROAD SOUTH, BLOOMFIELD, CT, 06002, US

(21) Appl. No.: 11/239,878

(22) Filed: Sep. 30, 2005

(51) Int. Cl. B32B 7/12

(52) U.S. Cl. 428/317.1; 428/317.3

(57) ABSTRACT

In one embodiment, a plastic layer can comprise a substrate layer and a contrast layer, wherein the film has a light transmission of less than or equal to about 10% as measured on a 0.050 inch thick film sample. The contrast layer can comprise a virgin plastic, a white pigment, and a non-white colorant. The contrast layer can have a whiteness index of greater than or equal to about 50, a contrast layer yellowness index of less than 10, and a brightness of greater than or equal to 50, as measured on a 3 mm thick color chip under D65 illuminant and 2 degree observer.

### BACKGROUND

This disclosure generally relates to plastic films, methods of manufacturing plastic films.

Polyimides possess many desirable properties, such as, for example, high heat resistance, flame retardance, dimensional stability, strength, chemical resistance, biocompatibility, high dielectric strength, and transparence. Correspondingly, polyetherimide is employed for the manufacture of a wide-range of articles. Some of these applications include automotive applications (e.g., air intake manifolds, fluids handling, lighting applications, electrical connectors), medical applications (e.g., vascular infusion ports, luer connectors, stopcocks, dialysis filters), aerospace applications (e.g., interior semi-structural components, interior cladding, fluids handling, electrical connections), and electrical applications (e.g., electrical connectors, structural components). Furthermore, polyetherimide lends itself to most forms of thermoplastic processing and conversion, such as extrusion, injection molding, and the like. Although polyetherimides possess these, and other beneficial properties, it's utility can be hindered in some applications due to it's inherent amber color. This is especially the case in applications in which bright white colors are desired.

U.S. Pat. No. 3,957,526 to Hodgkin et al., is directed to titanium dioxide pigments and fillers, and teaches adjusting surface chemistry of the titanium dioxide, and using the titanium dioxide in polymers. Hodgkin et al. teach, among other things that, when the titanium dioxide with the modified surface is used in polymers, dispersion is faster and better in non-aqueous systems.

U.S. Pat. No. 3,971,755 to Zannucci et al. notes that polymer compositions which contain titanium dioxide pigment are sometimes more susceptible to photodegradation and are more difficult to stabilize against such photodegradation than are the unpigmented polymers. Zannucci et al. state that “the addition of 20% titanium dioxide (Ti-Pure R-100) to polypropylene reduces the lifetime to embrittlement of 5-mil thick films from 4 days to 1.5 days (irradiated at 65°-70° C. with 3000 A lamps).” (Col. 1, lines 31-35) Zannucci et al., therefore, address ultraviolet light stabilization of polymer compositions, and more particularly address ultraviolet light stabilization of titanium dioxide-pigmented polymer compositions. In a preferred embodiment of Zannucci et al., the titanium dioxide pigmented polymer is a polyolefin, and particularly a propylene containing polyolefin such as polypropylene or a polypropylene having grafted thereto acrylic acid or maleic anhydride or acid. The titanium dioxide is used in an amount of from 0.05 weight percent (wt %) to about 50 wt %, based on the weight of the polymer, with 0.5 wt % to 10 wt % titanium dioxide preferred in a molding composition, 0.1 wt % to 2 wt % titanium dioxide preferred in a fiber forming composition, and 5 wt % to 30 wt % titanium dioxide preferred in a coating composition.

U.S. Pat. No. 4,388,425 to Strehler et al. is directed to concentrates of titanium dioxide in polycaprolactam. Concentrates of from 20 wt % to 50 wt % of titanium dioxide in polycaprolactam are taught.

U.S. Pat. No. 5,256,728 to Dardaris et al. is directed to polycarbonate compositions comprising unpacified titanium dioxide. The amount of titanium dioxide employed is about 1 wt % to 20 wt % based on polycarbonate. Due to the redistribution of the polycarbonate, the titanium dioxide may be unpacified (i.e., titanium dioxide free from a polysiloxane coating). Dardaris et al. teach preparing a pigmented polycarbonate composition by melt equilibrating a linear or branched polycarbonate in the presence of a catalytic amount of a carbonate redistribution catalyst selected from the group consisting of bases and Lewis acids, to form a redistributed polycarbonate; and blending said redistributed polycarbonate with an amount effective for pigmentation of titanium dioxide free from polysiloxane coating.

U.S. Pat. No. 6,410,614 to Jones et al. is directed to incorporating titanium dioxide into materials such as polyamides, copolyamides, polyester, polyolefins, and polyurethanes. The titanium dioxide particles are present in an amount between about 60 wt % to about 70 wt % of the composition.

U.S. Pat. No. 6,607,794 to Wilson et al. is directed to light reflecting molded articles comprising a thermoplastic or thermoset polymer matrix in which is dispersed rutile titanium dioxide and a flame retardant material. They teach that the combined effects of the impurities in ABS and the opacity of rutile titania below 420 nanometers render the light reflected from the article somewhat lacking at the blue end of the visible spectrum. This problem may be addressed through the use of clear, transparent matrix polymers. Hence, polymers useful according to Wilson et al. comprise those with yellowness indices (YI) values of less than about 10, preferably less than about 5, and most preferably less than about 2.

The above-identified patents are identified in an IDS filed herewith so the relevant Patent and Trademark Office Personnel can review these references in appropriate detail.

There remains a continuing need in the art for improvements to produce bright white polymer compositions and products from yellow polymers. In particular, there is a continuing need for improvements to produce opaque films.

### BRIEF SUMMARY

Disclosed herein are plastic films and methods of making the films, and labels made therefrom.

In one embodiment, a plastic film can comprise a substrate layer and a contrast layer, wherein the film has a light transmission of less than or equal to about 10% as measured on a 0.050 inch thick film sample from the contrast layer side of the film. The contrast layer can comprise a virgin plastic, a white pigment, and a non-white colorant. The contrast layer can have a whiteness index of greater than or equal to about 50, a contrast layer yellowness index of less than 10, and a brightness of greater than or equal to 50, as measured on a 3 mm thick color chip under D65 illuminant and 2 degree observer.

In another embodiment, the plastic film can comprise: a substrate layer comprising a plastic and an opaque filler and a contrast layer. The film has a light transmission of less than or equal to about of less than or equal to 10% as measured on a 0.050 inch thick film sample from the contrast layer side of the film. The contrast layer can comprise: polyimide, a white pigment, and a non-white colorant. The contrast layer can have a whiteness index of greater than or equal to about 50, a contrast layer yellowness index of less than or equal to about 15, and a brightness of greater than or equal to 50, as measured on a 3 mm thick color chip under D65 illuminant and 2 degree observer.

The above described and other features are exemplified by the following figures and detailed description.

### BRIEF DESCRIPTION OF THE DRAWINGS

Refer now to the figures, which are exemplary embodiments.

FIG. 1 is a graphical representation of the change in yellowness index for high heat polycarbonates after thermal aging at 160° C. over time.

FIG. 2 is a graphical representation of rheological testing of Sample 4 and unfilled polyetherimide.

FIG. 3 is a graphical representation of a thermal gravimetric analysis of Sample 4 and unfilled polyetherimide.

FIG. 4 is a graphical representation of total light transmission of Sample 4.

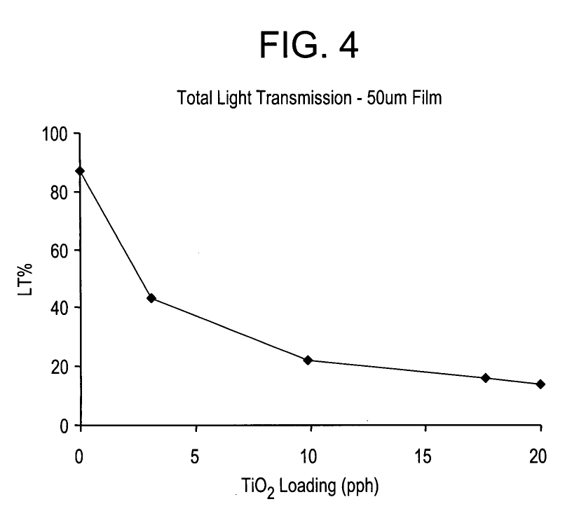

### DETAILED DESCRIPTION

At the outset, it should be noted that ranges might be disclosed herein which are inclusive and combinable (e.g., ranges of “up to about 25 parts per hundred by weight (pph), with about 5 pph to about 20 (pph) desired”, is inclusive of the endpoints and all intermediate values of the ranges of “about 5 (pph) to about 25 (pph),” etc). Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants).

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group. Unless specifically specified otherwise, all parts per hundred (pph) discussed herein are by weight, per 100 parts of the plastic (e.g., polyetherimide or the like).

Unless specifically specified to the contrary, yellowness, whiteness, and brightness were determined using 3 millimeter (mm) color chips, prepared by using an 85 ton injection molder at molding temperatures of 640° F. (338° C.) to 680° F. (360° C.) with a mold temperature of 225° F. (107° C.), that were spectroscopically analyzed on a GretagMacbeth Color Eye 7000 spectrophotometer. Yellowness Index (YI) is determined per ASTM E313-73 (D1925) under D65 illuminant and 2 degree observer, Whiteness Index (WI) is determined according to CIE Ganz 82 (as specified the GretagMacbeth spectrophotometer manual), and Brightness Index (Br) is determined according to TAPPI T542 (1987). All tests and methodology involved in performing these tests are known to the ordinary skilled artisan.

High temperature films (e.g., labels) are employed in many applications, such as bar code applications and general product labeling, which can serve multiple industries such as, electronics, automotive, and high temperature appliances. Polyetherimide (“PEI”) has been successfully employed as high temperature films in these applications, however it's generally superior physical properties are offset due to the materials inherent amber color and translucency. In monolayer designs, PEI films generally result in a product that exhibits high yellowness, low brightness, and higher light transmittance than is desired.

Opaque films (e.g., comprising a laminate) of a contrast layer(s) and a substrate layer have been developed that are capable of providing a whiteness index (WI) of greater than or equal to about 70, a yellowness index (YI) of less than or equal to about 10, and a light transmission of less than or equal to 10%, or, more specifically, less than or equal to 5%, as measured on a 50 micrometer (μm) thick film sample using a GretagMacbeth Color Eye 7000 spectrophotometer, from the contrast layer side of the film. The contrast layer can be disposed on one or both sides of the substrate layer. In addition to the substrate layer and contrast layer(s), the film can further comprise adhesive layer(s), coating(s), and so forth.

In one embodiment, an opaque film can comprise a substrate layer and a contrast layer(s). The substrate layer can comprise an opaque composition that can provide decreased light transmission and offer a non-obvious benefit of decreased yellowness and increased whiteness of the contrast layer. Possible substrate compositions include a plastic and an opaque filler. The plastic can be any plastic that is compatible with and can be bonded to the contrast layer. The types of plastics include those used with the contrast layer, as well as others. With the substrate layer, the yellowness index of the plastic is not an issue since the substrate layer comprises an opaque filler that will mask the plastic's yellowness. Possible opaque filler(s) include any material that can be added to the substrate plastic to form a film having a light transmission of less than 5% at a thickness of 50 μm, and at an opaque filler loading of less than or equal to about 50 pph. Some possible opaque fillers include carbon black, graphite, clay, black iron oxide, aniline black, anthraquinone black, blue (e.g., Prussian blue), and so forth, as well as combinations comprising at least one of the foregoing fillers.

The contrast layer can comprise a plastic composition, e.g., comprising virgin plastic, a white pigment, and a non-white colorant. This plastic composition can provide high whiteness and low yellowness, which is desirable for providing printing contrast. Actually, with virgin plastics that have a yellowness index (YI) of greater than or equal to about 35, it can be difficult to form products having a light color, a bright color, and/or being bright white. Virgin plastic is plastic as made (polymers, copolymers, and so forth), without additional ingredients, and includes plastic that has a YI index of great than 11 (or, more specifically, greater than 20) before processing, and plastic that is capable of having a YI of greater than 11 (or, more specifically, greater than 15) after processing and/or aging (such as thermal and/or photo aging). For example, it can be difficult to attain the plastic with a YI of less than 10 when the initial YI is greater than or equal to about 20, or, more specifically greater than or equal to about 30, or, even more specifically, greater than or equal to about 40, yet more specifically, greater than or equal to about 50, and even more specifically, greater than or equal to about 60. Yet, it is desirable to form a plastic composition and/or product from a plastic having an initial YI of greater than or equal to about 35 can be produced with a YI of less than or equal to about 15, or, more specifically, YI of less than 10. Plastic compositions that can be employed to form the contrast layer include those disclosed in U.S. patent application Ser. No. ______, Attorney Docket No. 184112-1 to Feng Cao et al., filed concurrently herewith (and hereby incorporated herein in its entirety).

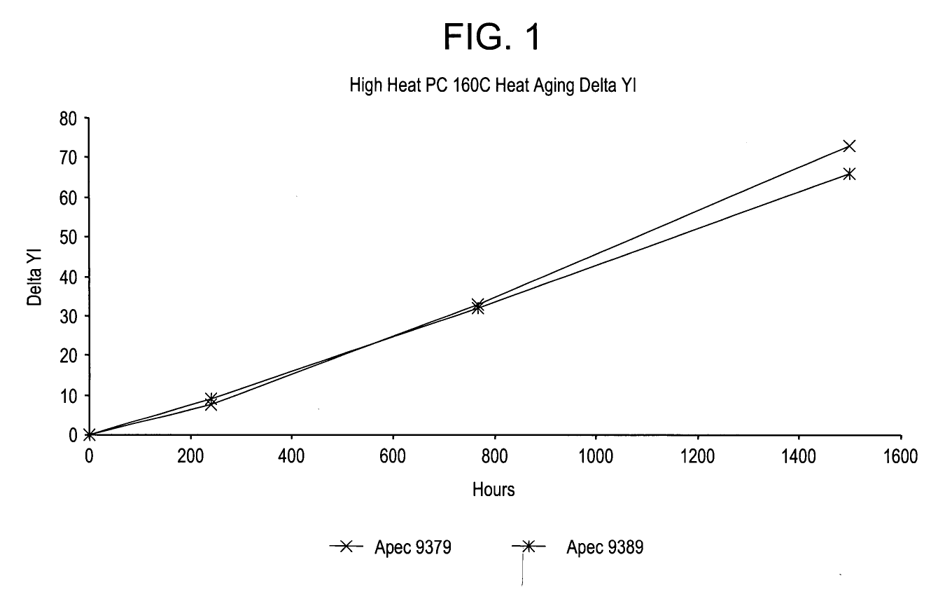

Some plastics, even those having low initial YI values (e.g., less than 10), can have a high YI after processing (such as abusive molding (e.g., where the plastic dwells in the molder barrel for an extended period of time under elevated molding temperatures that may cause thermal degradation of the polymer), and/or YI that increases over time, for example, due to aging (such as photo aging and/or thermal aging). A change in YI over time with thermal aging is illustrated in FIG. 1 for high heat polycarbonate (PC) which show that the YI increases over time.

As with materials that have an initially high YI, production of final products having a low YI, high whiteness (WI), and high brightness is desirable. Plastics that would otherwise having a plastic YI of greater than 11, or, more specifically, greater than or equal to about 15, or, more specifically greater than or equal to about 20, or, even more specifically, greater than or equal to about 25, and even more specifically, greater than or equal to about 40, can be produced with a YI of less than 10, i.e., a YI for the plastic itself without the white pigment and non-white colorant(s), after processing and aging, of less than 10. In other words, plastics that either have an initial YI of greater than 11, and/or whose final YI after processing and/or aging is greater than 11, etc., can be formed into products with a YI of less than 10.

Possible plastics that inherently have or can attain a YI of greater than 11 (e.g., at a point in time such as virgin material, after processing, and/or after aging) include: polycarbonates (e.g., high heat polycarbonate having a glass transition temperature of greater than or equal to 170° C., iso-terephthalic resorcinol), polyarylene ethers, polyphenylenes, polysulfones, aromatic polysulfides, polyimides (e.g., polyetherimide), polyarylates, polyketones (such as polyetheretherketone), and others. Also included in these plastics are combinations comprising at least one of the foregoing plastics, as well as reaction products formed from a reaction with at least one of the foregoing plastics. Polycarbonates (including copolycarbonates) include Lexan® PC, Lexan® PPC and the iso-terephthalic resorcinol based Lexan® PEC resins all commercially available from General Electric Plastics, Pittsfield, Mass. and APEC® PEC resin commercially available from Bayer MaterialScience LLC, Pittsburgh, Pa., as well as polycarbonate/polyester blends commercially available under the trademark Xylex® resins also from General Electric Plastics, Pittsfield, Mass. Polyarylene ethers include Noryl® PPO resins commercially available from General Electric Plastics, Pittsfield, Mass. Polyphenylenes include Parmax® commercially available from Mississippi Polymer Technologies, Inc., Bay Saint Louis, Mo.). Polysulfones include Ultrason S and Ultrason E, commercially available from BASF Corporation, Florham, N.J., as well as Radel A, Radel R, Supradel, and Udel reins commercially available from Solvay Advanced Polymers Alpharetta, Ga. Polyimides (such as polyetherimides) include Aurum® commercially available from Mitsui Chemicals America, Inc., Purchase, N.Y., and Vespel® resins commercially available from DuPont™, Wilmington, Del., as well as Ultem® rein commercially available from General Electric Plastics, Pittsfield, Mass. Polyarylates include U-Polymer commercially available from Unitika Plastics Division, Osaka, Japan. Polyketones include Victrex® PEEK™ and Victrex® PEK™ from Victrex plc Lancashire UK, Kadel® PAEK from Solvay Advanced Polymers. Also included in these plastics are combinations comprising at least one of the foregoing plastics, as well as reaction products formed from a reaction with at least one of the foregoing plastics.

Polyetherimide comprises desirable performance characteristics. The material possesses high heat resistance, excellent mechanical properties, excellent solvent resistance, flame retardance, dimensional stability, biocompatibility, and high dielectric strength. Polyetherimide (PEI) however possesses a deep amber color that differentiates itself from other polymers. Although the polymers color is acceptable in many applications, in some applications it is undesirable, such as labeling or printed surface applications, for example, contrast applications. As a result, the acceptance of PEI has been hindered in these applications due to the materials inherent yellowness.

As will be discussed in greater detail below, the plastic compositions and products produced with the YI of less than 10, can also have a whiteness index (WI) of greater than or equal to about 50, or, more specifically, greater than or equal to about 60, or, even more specifically, greater than or equal to about 70, and, yet more specifically, greater than or equal to about 75. Additionally, these compositions and products can attain a brightness (Br) of greater than or equal to about 50, or, more specifically, greater than or equal to about 60, or yet more specifically, greater than or equal to about 70, and, even more specifically, greater than or equal to about 72. For example, polyetherimide resin compositions comprising polyetherimide resin, white pigment, and a colorant have been developed that are capable producing a bright white articles comprising a whiteness index (WI) of greater than or equal to about 70, a yellowness index (YI) of less than or equal to about 10, and a brightness (Br) of greater than or equal to 72.

Thermoplastic polyimides have the general formula (1): 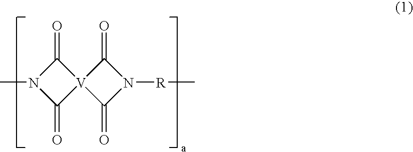
wherein a is more than 1, typically about 10 to about 1,000 or more, or more specifically about 10 to about 500; and wherein V is a tetravalent linker without limitation, as long as the linker does not impede synthesis or use of the polyimide. Suitable linkers include but are not limited to: (a) substituted or unsubstituted, saturated, unsaturated or aromatic monocyclic and polycyclic groups having about 5 to about 50 carbon atoms, (b) substituted or unsubstituted, linear or branched, saturated or unsaturated alkyl groups having 1 to about 30 carbon atoms; or combinations comprising at least one of the foregoing. Suitable substitutions and/or linkers include, but are not limited to, ethers, epoxides, amides, esters, and combinations comprising at least one of the foregoing. At least a portion of the linkers V contain a portion derived from a bisphenol. Desirably linkers include but are not limited to tetravalent aromatic radicals of structures (2) 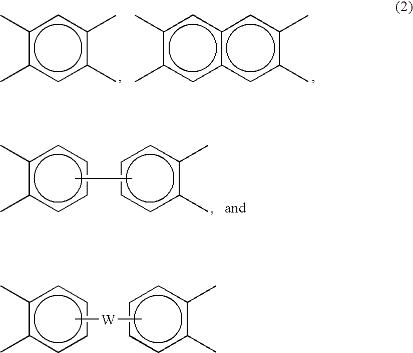
wherein W is a divalent moiety including —O—, —S—, —C(O)—, —SO2-, —SO—, -CyH2y- (y being an integer from 1 to 5), and halogenated derivatives thereof, including perfluoroalkylene groups, or a group of the formula —O-Z-O— wherein the divalent bonds of the —O— or the —O-Z-O— group are in the 3,3′, 3,4′, 4,3′, or the 4,4′ positions, and wherein Z includes, but is not limited, to divalent radicals of formulas (3). 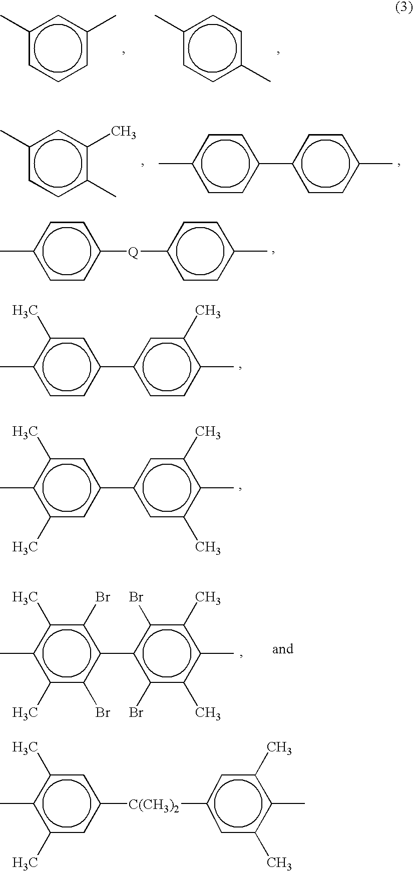
wherein Q includes but is not limited to a divalent moiety including —O—, —S—, —C(O)—, —SO2-, —SO—, -CyH2y- (y being an integer from 1 to 5), and halogenated derivatives thereof, including perfluoroalkylene groups.

R in formula (1) includes but is not limited to substituted or unsubstituted divalent organic radicals such as: (a) aromatic hydrocarbon radicals having about 6 to about 20 carbon atoms and halogenated derivatives thereof; (b) straight or branched chain alkylene radicals having about 2 to about 20 carbon atoms; (c) cycloalkylene radicals having about 3 to about 20 carbon atoms, or (d) divalent radicals of the general formula (4) 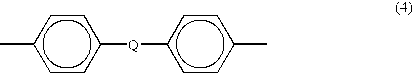
wherein Q includes but is not limited to a divalent moiety including —O—, —S—, —C(O)—, —SO₂—, —SO—, —C_{y}H_{2y}— (y being an integer from 1 to 5), and halogenated derivatives thereof, including perfluoroalkylene groups.

Exemplary classes of polyimides include polyamidimides and polyetherimides, particularly those polyetherimides which are melt processible, such as those whose preparation and properties are described in U.S. Pat. Nos. 3,803,085 and 3,905,942.

Exemplary polyetherimide resins comprise more than 1, typically about 10 to about 1,000, or more specifically, about 10 to about 500 structural units, of the formula (5) 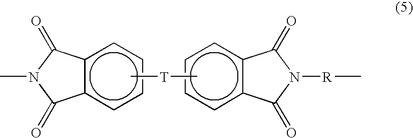
wherein T is —O— or a group of the formula —O-Z-O— wherein the divalent bonds of the —O— or the —O-Z-O— group are in the 3,3′, 3,4′, 4,3′, or the 4,4′ positions, and wherein Z includes, but is not limited, to divalent radicals of formula 10 as defined above.

In one embodiment, the polyetherimide may be a copolymer which, in addition to the etherimide units described above, further contains polyimide structural units of the formula (6) 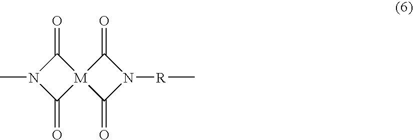
wherein R is as previously defined for formula (1) and M includes, but is not limited to, radicals of formulas (7).

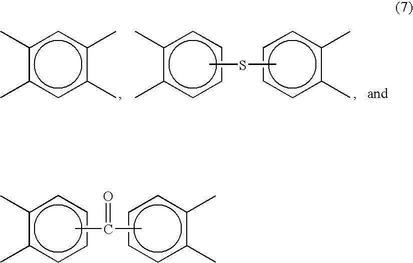

The polyetherimide can be prepared by various methods, including, but not limited to, the reaction of an aromatic bis(ether anhydride) of the formula (8) 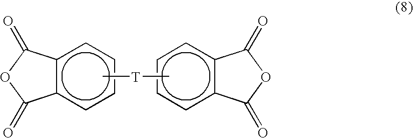
with an organic diamine of the formula (9)
H₂N—R—NH₂ (9)
wherein R and T are defined in relation to formulas (1) and (5).

Examples of specific aromatic bis(ether anhydride)s and organic diamines are disclosed, for example, in U.S. Pat. Nos. 3,972,902 and 4,455,410. Illustrative examples of aromatic bis(ether anhydride)s of formula (8) include: 2,2-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as various mixtures comprising at least one of the foregoing.

The bis(ether anhydride)s can be prepared by the hydrolysis, followed by dehydration, of the reaction product of a nitro substituted phenyl dinitrile with a metal salt of a bisphenol compound (e.g., BPA) in the presence of a dipolar, aprotic solvent. An exemplary class of aromatic bis(ether anhydride)s included by formula (8) above includes, but is not limited to, compounds wherein T is of the formula (10): 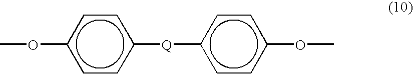
and the ether linkages, for example, are in the 3,3′, 3,4′, 4,3′, or 4,4′ positions, and mixtures comprising at least one of the foregoing, and where Q is as defined above.

Any diamino compound may be employed. Examples of suitable compounds are ethylenediamine, propylenediamine, trimethylenediamine, diethylenetriamine, triethylenetetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis (3-aminopropyl)amine, 3-methoxyhexamethylenediamine, 1,2-bis(3-aminopropoxy)ethane, bis(3-aminopropyl) sulfide, 1,4-cyclohexanediamine, bis-(4-aminocyclohexyl)methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl)methane, bis(2-chloro-4-amino-3,5-diethylphenyl)methane, bis(4-aminophenyl)propane, 2,4-bis(b-amino-t-butyl)toluene, bis(p-b-amino-t-butylphenyl)ether, bis(p-b-methyl-o-aminophenyl)benzene, bis(p-b-methyl-o-aminopentyl)benzene, 1,3-diamino-4-isopropylbenzene, bis(4-aminophenyl)sulfide, bis(4-aminophenyl)sulfone, bis(4-aminophenyl)ether and 1,3-bis(3-aminopropyl)tetramethyldisiloxane. Mixtures of these compounds may also be present. Desirably, the diamino compounds are aromatic diamines, especially m- and p-phenylenediamine and mixtures comprising at least one of the foregoing.

In one embodiment, the polyetherimide resin comprises structural units according to formula 5 wherein each R is independently p-phenylene or m-phenylene or a mixture comprising at least one of the foregoing and T is a divalent radical of the formula (11)

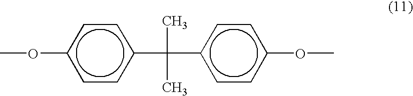

Included among the many methods of making the polyimides, particularly polyetherimides, are those disclosed in U.S. Pat. Nos. 3,847,867, 3,850,885, 3,852,242, 3,855,178, 3,983,093, and 4,443,591.

he reactions can be carried out employing solvents, e.g., o-dichlorobenzene, m-cresol/toluene and the like, to effect a reaction between the anhydride of formula (8) and the diamine of formula (9), at temperatures of about 100° C. to about 250° C. Alternatively, the polyetherimide can be prepared by melt polymerization of aromatic bis(ether anhydride)s (8) and diamines (9) by heating a mixture of the starting materials to elevated temperatures with concurrent stirring. Generally, melt polymerizations employ temperatures of about 200° C. to about 400° C. Chain stoppers and branching agents may also be employed in the reaction.

When polyetherimide/polyimide copolymers are prepared, a dianhydride, such as pyromellitic anhydride, is used in combination with the bis(ether anhydride). The polyetherimide resins can optionally be prepared from reaction of an aromatic bis(ether anhydride) with an organic diamine in which the diamine is present in the reaction mixture at less than or equal to about 0.2 molar excess. Under such conditions the polyetherimide resin may have less than or equal to about 15 microequivalents per gram (μeq/g) acid titratable groups, or, more specifically less than or equal about 10 μeq/g acid titratable groups, as shown by titration with chloroform solution with a solution of 33 weight percent (wt %) hydrobromic acid in glacial acetic acid. Acid-titratable groups are essentially due to amine end-groups in the polyetherimide resin.

One route for the synthesis of polyetherimides proceeds through a bis(4-halophthalimide) having the following structure (12): 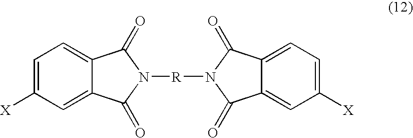
wherein R is as described above and X is a halogen. The bis(4-halophthalimide) wherein R is a 1,3-phenyl group (13) is particularly useful.

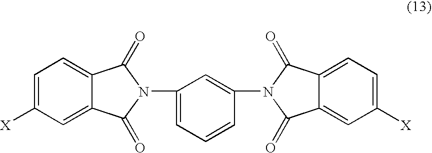

Bis(halophthalimide)s (12) and (13) are typically formed by the condensation of amines, e.g., 1,3-diaminobenzene with anhydrides, e.g., 4-halophthalic anhydride (14):

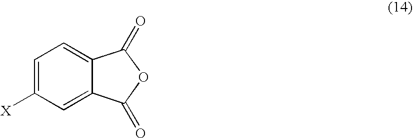

Polyetherimides may be synthesized by the reaction of the bis(halophthalimide) with an alkali metal salt of a bisphenol such as bisphenol A or a combination of an alkali metal salt of a bisphenol and an alkali metal salt of another dihydroxy substituted aromatic hydrocarbon in the presence or absence of phase transfer catalyst. Suitable phase transfer catalysts are disclosed in U.S. Pat. No. 5,229,482. Suitable dihydroxy substituted aromatic hydrocarbons include those having the formula (15)
OH-A²OH (15)
wherein A² is a divalent aromatic hydrocarbon radical. Suitable A² radicals include m-phenylene, p-phenylene, 4,4′-biphenylene, and similar radicals.

Some virgin PEIs comprise a yellowness index (YI) of about 55 or greater. Experiments can be conducted (See Table 1 below) where a white pigment can be integrated into a polyetherimide resin in an effort to reduce the yellowness of the material. More specifically, titanium dioxide (TiO₂) was added at a 10 parts per hundred parts polyetherimide. At this loading, the white pigment produced a “creamy” colored polymer that will exhibit a high yellowness which is unacceptable for most applications requiring a “bright white” polymer. Even with TiO₂ as high as 30 pph the visual properties of these materials in terms of the yellowness of the composition, remained unacceptably high compared to a commercially accepted standard, even when the concentration of the TiO₂ reached 30 pph.

To achieve the desired low yellowness, e.g., bright white product, a non-white colorant can be added to a plastic composition. The colorant can comprise any pigment, dye, or the like, as well as combinations comprising at least one of the foregoing that adjusts the yellowness of the composition as desired. In other words, non-white color can be added to a plastic to increase the whiteness of the plastic, by reducing the yellowness. The non-white colorant can be a color that exhibits a reflectance of greater than or equal to about 15%, or, more specifically, greater than or equal to about 25%, or, even more specifically, greater than or equal to about 30%, and, yet more specifically, greater than or equal to about 35%, at wavelengths of about 380 nanometers (nm) to about 580 nm. The reflectance is measured from a 3 mm thick color chip made with the virgin polymer and the non-white colorant, utilizing a GretagMacbeth Color Eye 7000 spectrophotometer, wherein the chip comprises the polymer resin, TiO₂, and the colorant at a loading level sufficient to be detected for reflectance by the spectrophotometer.

The non-white colorant can be present in an amount of about 0.0001 to about 1.0 pph, or more specifically, about 0.005 pph to about 0.5 pph, or more specifically, about 0.01 pph to about 0.25 pph, and yet more specifically, about 0.05 pph to about 0.15 pph, and can be any colorant with the desired spectral properties. Exemplary non-white colorants comprise, but are not limited to, C.I. Solvent Violet 13, C.I. Solvent Violet 36, C.I. Pigment Blue 15:4, C.I. Pigment Blue 29, and the like, as well as combinations comprising at least one of the foregoing.

The plastic composition with a YI of less than or equal to about 10 comprises a white pigment in an amount of about 18 parts per hundred (pph) to about 45 pph, or more specifically, about 20 pph to about 35 pph, or even more specifically, about 20 pph to about 30 pph. Suitable white pigments can comprise, but are not limited to, C.I. Pigment White (such as C.I. Pigment White 4, C.I. Pigment White 5, C.I. Pigment White 6, C.I. Pigment White 6, C.I. Pigment White 6:1, C.I. Pigment White 7, C.I. Pigment White 8, C.I. Pigment White 9, C.I. Pigment White 10, C.I. Pigment White 11, C.I. Pigment White 12, C.I. Pigment White 13, C.I. Pigment White 14, C.I Pigment White 15, C.I. Pigment White 17, C.I. Pigment White 18, C.I. Pigment 18:1, C.I. Pigment White 19, C.I. Pigment White 20, C.I. Pigment White 21, C.I. Pigment White 22, C.I. Pigment White 23, C.I. Pigment White 24, C.I. Pigment White 25, C.I. Pigment White 26, C.I. Pigment White C.I. Pigment White 28, C.I. Pigment White 30, C.I. Pigment White 32, C.I. Pigment White 33, C.I. Pigment White 34, and so forth), titanium dioxide, aluminum phosphate, aluminum trihydroxide, white potassium iodide, calcium silicate, zirconium carbonate, barium titanate, and the like, as well as combinations comprising at least one of the foregoing. With a polyetherimide composition, for example, a white composition can be obtained with a weight ratio of white pigment (such as titanium dioxide) to the other non-white colorant(s) of about 1:0.0001 to about 1:0.01, e.g., about 1:0.0002 to about 1:0.0005.

The non-white colorant and white pigment can be mixed into the plastic utilizing any method. However a masterbatch or masterblend processes can be employed for ease of use for the end-user. A masterbatch generally refers to a process of dispersing the materials (e.g., non-white colorant, white pigment, additive (such as filler, stabilizer, modifier, processing aid, antimicrobial, and so forth)) in a carrier (e.g., thermoplastic, wax, and the like) by employing melt-processing equipment (e.g., batch mixers, continuous mixers, twin screw compounding extruder, single screw extruder, and the like) to produce a masterbatch that can be in a pelletized or beaded form. These pellets or beads can then be added to a base resin at a specific ratio to color the base resin during a melt processing operation, which can be concurrent with the production of an article of manufacture.

Masterblends are similar to masterbatch formulations however are not engineered as a concentrated additive. Masterblends generally are formulated to comprise all the materials (e.g., non-white colorant, white pigment, additive (such as filler, stabilizer, modifier, processing aid, antimicrobial, and so forth)) in a carrier (e.g., thermoplastic, wax, and the like), which can be processed into an end product as without additional mixing. Masterblends are generally produced on continuous melt processing equipment (e.g., continuous mixers, twin screw compounding extruder, single screw extruder, and the like), which form pellets or beads that comprise the specific concentration of the material. These pellets or beads can then be utilized in any melt processing operation to form an article of manufacture.

In addition to non-white colorants, additional additive(s) can be integrated within the composition. These additional additive(s) can be any chemical which provides a benefit without inhibiting attaining the desired YI value (e.g., at the amount the additive is used in the plastic); e.g., if they do not interfere with obtaining the desired color matching (e.g., obtaining the desired whiteness). Some possible additives include, but are not limited to, flame retardant(s) (e.g., halogenated material(s), organic phosphate(s), Rimar salt, and so forth), light stabilizer(s), fluorescent whitening agent(s), optical brightener(s), antioxidant(s), anti-static agent(s), blowing agent(s), processing aid(s), antioxidant(s), reinforcing agent(s), compatibilizer(s), filler(s) (e.g., to modify the physical properties of the polymer), and so forth, as well as combinations comprising at least one of the foregoing additives.

In one embodiment a masterblend can be prepared and extruded (or co-extruded) to form a film. In this example, a masterblend can first be prepared by combining polyetherimide (e.g. Ultem, commercially available from General Electric Company, Fairfield, Conn.), with solvent violet 13, solvent violet 36 (commercially available from Lanxess AG, Laverkussen, Germany), and titanium dioxide (such as that commercially available from E.I. Dupont, Mineral Products, Wilmington Del., and Millenium Inc. Hunt Valley, Md.). Once combined, these materials can be dry blended (e.g. tumbled) to initially disperse the colorants among the plastic pellets and/or powder. It is desirable that the colorants adhere to the pellets and/or powder, therefore surfactants and/or wetting agents can be employed.

After blending, the batch can optionally be dried, and then fed into a co-rotating twin-screw extruder. The extrusion process can mechanically reduce pigment agglomerates and disperse the non-white colorants throughout the polymer. The products of this compounding process can be strands of molten polymer in which the colorants are homogeneously dispersed. The strands can be cooled in a water bath, pelletized, dried, and packaged prior to further processing. The white plastic (e.g., white polyetherimide) composition produced can then be employed for the production of any desirable article of manufacture, even articles that have light colors whose color was otherwise not previously attainable or maintainable (e.g., after processing and/or aging) with that plastic. A co-extruded sheet can be produced for example, which comprises a non-filled polyetherimide base layer and a white polyetherimide top layer. In another example, a white electrical appliance housing can be produced comprising the white plastic via an injection molding process.

Highly opaque films can employ plastic, with the same or different plastic employed for both the contrast layer(s) and the substrate layer. Utilizing plastics with a YI of greater than 11 in the contrast layer(s) however poses an obstacle in that the materials inherent deep amber color imparts a yellow hue. More specifically, the yellowness of virgin PEI, for example, can be as high as 66 when analyzing a 0.100-inch thick film per ASTM E313-98 using a GretagMacbeth Color Eye 7000 spectrophotometer. Although it is conceivable that a white pigment, such as titanium dioxide, can be added to the resin to reduce the materials yellowness, the inherent hue remains unacceptably high even at high loadings of pigment (as will be experimentally shown). However, compositions comprising polyetherimide, a white pigment and a non-white colorant have been developed wherein the additives are capable of suppressing the inherent yellowness of the PEI and producing a composition that exhibits low yellowness and high whiteness, which are desirable for use in the contrast layer of highly opaque films.

More specifically, the contrast layers composition can comprise; about 18 pph to about 45 pph white pigment, and about 0.0001 pph to about 1.000 pph of the non-white colorant. The non-white colorant can be a colorant that, when combined with the plastic and formed into a 3 mm color chip, exhibits a reflectance at or above 35% between the wavelength of about 380 nanometers (nm) to about 580 nm as measured utilizing a GretagMacbeth Color Eye 7000 spectrophotometer.

Referring now to Table 1, polyetherimide (e.g., Ultem®, commercially available from General Electric Plastics, Pittsfield, Mass.) samples are presented with their corresponding compositions, and several of their measured visual attributes including yellowness index (YI), whiteness (WI), and brightness (Br).

The samples tested were prepared by the following method: the components of the formulation (polyetherimide powder, TiO₂, additives and non-white colorants) were precisely weighed and combined in a container. The components were mixed by placing the container within a Harbil paint mixer (model 5G-HD made by Fluid Management Inc located at Wheeling, Ill. 60090) and shaken for 5 minutes. Pellets were formed by extruding the mixture utilizing a 24 mm twin extruder (Model TSE 24HC by Prizm). The zone temperatures of the extruder were set at temperatures between 400° F. (204° C.) and 650° F. (343° C.) and the screw speed was 600 rotations per minute (rpm).

The pellets were used to injection mold 50 mm by 100 mm color chips having a thickness of 3 mm using an 85 Ton Injection Molder Model FN1000 by Nessei Plastic Industrial Co. The molding temperatures were 640° F. (338° C.) to 680° F. (360° C.) with a mold temperature of 225° F. (107° C.). The color chips were spectroscopically analyzed on a GretagMacbeth Color Eye 7000 spectrophotometer to determine Yellowness Index (YI) per ASTM E313-73 (D1925) under D65 illuminant and 2 degree observer, Whiteness Index (WI) according to Ganz 82, and Brightness Index (Br) according to TAPPI T542 (1987).

As can be seen in Table 1 below, the baseline PEI, and Sample 1 through Sample 5 comprised polyetherimide resin (PEI; Ultem®). Sample 6 comprised polyvinyl fluoride (PVF). (Note: The PVF sample represents the current industry standard for acceptable visual properties, the sample was sold under the tradename Tedlar® produced by Dupont, Wilmington, Del., and has proven commercial acceptance.)

TABLE 1

| | Composition (pph) | | | | | |
|---|---|---|---|---|---|---|
| No. | PEI | TiO₂ | Non-white colorant | YI | WI | Br |
| — | 100 | — | — | 64.7 | −144.1 | 29.7 |
| 1 | 100 | 10 | — | 20.3 | 42.8 | 72.5 |
| 2 | 100 | 20 | — | 17.5 | 53.5 | 76.6 |
| 3 | 100 | 30 | — | 16.3 | 58.6 | 79.1 |
| 4 | 100 | 20 | 0.0015 SV 13¹ | 9.7 | 69.1 | 76.1 |
| | | | 0.0048 SV 36² | | | |
| | | | 0.0026 PB 24³ | | | |
| 5 | 100 | 20 | 0.0070 SV 13¹ | 6.0 | 74.0 | 76.6 |
| | | | 0.0002 SV 36² | | | |

| | | | | | |
|---|---|---|---|---|---|
| 6 | PVF Film | (not available) | 7.1 | 71.1 | 72.8 |

¹SV 13 = Solvent Violet 13
²SV 36 = Solvent Violet 36
³PB 24 = Pigment Blue 24

Sample 1 is a polyetherimide chip comprising 10 pph TiO₂ (by weight) based on resin. Comparing the yellowness index (YI) of this chip to the PVF standard, it can be seen that Sample 1 exhibits a YI value of 20.3 compared to 7.1 for the PVF standard (Sample 6). Also, it can be seen that Sample 1 exhibits a whiteness (WI) of 42.8 compared to 71.1 for the PVF standard, and exhibits a brightness (Br) of 72.5 compared to 72.8 for the PVF standard. From these results, it can be determined that the composition of Sample 1, comprising 10 pph TiO₂ (by weight), demonstrates undesirably high yellowness, an undesirably low whiteness, and comparable brightness to the PVF sheet standard.

Sample 2 comprises an increased loading of TiO₂ compared to Sample 1, with 20 pph by weight. At this increased loading, Sample 2 exhibited a yellowness of 17.5 compared to 7.1 for the PVF standard (Sample 6), whiteness was 53.5 compared to 71.1 for the PVF standard, and brightness was 76.6 compared to 72.8 for the PVF standard. From these results, it can be determined that the additional TiO₂ loading in Sample 2, compared to Sample 1, decreased yellowness (from 20.3 to 17.5), increased whiteness (from 42.8 to 53.5) and increased brightness (from 72.5 to 76.6). However, Sample 2 continued to demonstrate undesirably high yellowness, undesirably low whiteness, and comparable brightness to the PVF standard.

When TiO₂ loading is yet increased further, up to a loading of 30 pph (by weight) in Sample 3, yellowness was still higher than the PVF standard, namely 18.1 compared to 7.1, and the whiteness had only increased up to 58.6, which remained lower than the PVF standards value of 71.1. From these experiments, it can be determined that increasing titanium dioxide loading did not increase whiteness or decrease yellowness to the values exhibited by the PVF standard.

Next, Sample 4 was evaluated. This sample comprised 20 pph (by weight) TiO₂ and 0.0089 pph of non-white colorants (namely 0.0015 pph Solvent Violet 13, 0.0048 pph Solvent Violet 36, and 0.0026 pph Pigment Brown 24). From the visual properties recorded, the non-white colorants decreased the yellowness of the sample to 9.7, and increased the whiteness to 69.1 as compared to the values exhibited by Sample 2 (which also comprised 20 pph TiO₂, but no non-white colorants). Furthermore, comparing Sample 4 to the PVF standard, Sample 4 produced a whiteness value of 69.1 compared to 71.1 for the PVF standard (Sample 6), and produced a brightness value of 76.1 compared to 72.8 for the PVF standard. Therefore, it can be concluded that the addition of non-white colorants produced an article with more desirable visual attributes than compared to an article with only titanium dioxide. Also, it can be concluded that an article produced with a composition comprising titanium dioxide and non-white colorants yield visual properties that approach the visual properties of the PVF standard.

Yet further, when the visual properties were evaluated for Sample 5, whose composition comprises 20 pph TiO₂ and 0.0072 pph non-white colorants (namely 0.0070 pph Solvent Violet 13 and 0.0002 pph Solvent Violet 36), the samples yellowness was 6.0 compared to 7.1 for the PVF standard (Sample 6), the samples whiteness was 74.0 compared to 71.1 for the PVF standard, and brightness was 76.6 compared to 72.8 for the PVF standard. From this data, it can therefore be concluded that the addition of a non-white colorant(s) can produce a product exhibiting higher whiteness, lower yellowness, and higher brightness than the PVF standard, Sample 6.

In addition to visual performance testing, a rheological analysis was performed to evaluate melt processability. Analysis of Sample 4 and the base Ultem® resin (comprising no additives) were conducted on a capillary rheometer to evaluate the influence of the integration of the additives to the flow properties. Melt viscosities of polymers predominantly determine the processing characteristics of a polymer. High melt viscosity polymer compositions (for example materials comprising a melt flow index of about 2 and about 8 grams per 10 minutes) can be desirable for extrusion, blown film, and sheet extrusion applications. Furthermore polymer compounds with moderate melt viscosities (for example materials comprising a melt flow index of about 8 and about 20 grams per 10 minutes) can be desirable for extrusion, and injection molding applications. Lastly, polymer compounds with low melt viscosities (for example materials comprising melt flow index values of about 20 to about 60 grams per 10 minutes) can be desirable for high flow injection molding operations and the like.

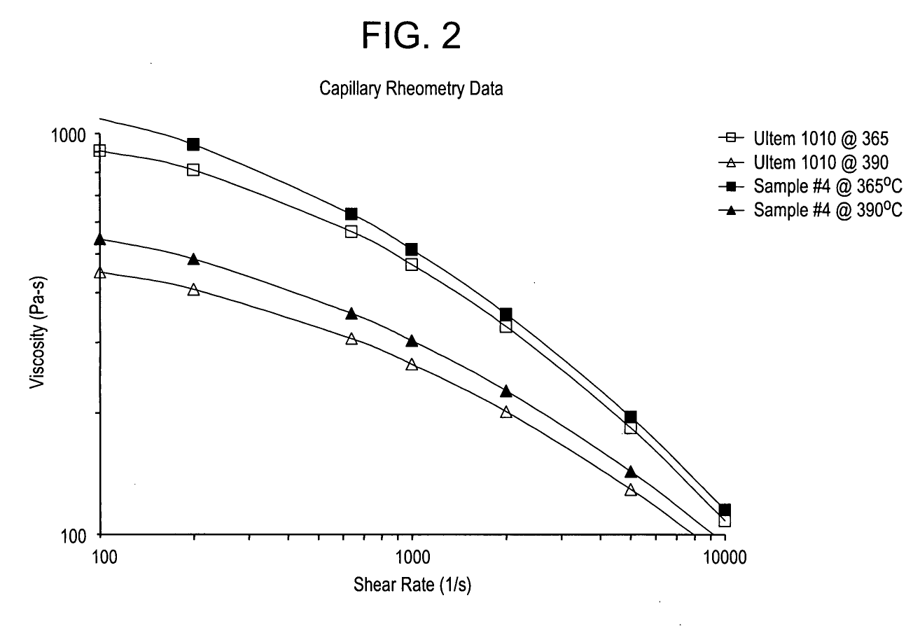

As can be seen in FIG. 2, an exemplary graph presenting viscosity (measured in pascal-seconds, Pa·s), versus shear rate (measured in inverse seconds, 1/s) of Sample 4 is presented. In addition, an unfilled polyetherimide graph is presented as well for comparative purposes, which is illustrated as “Ultem 1010”. In the graph it can be seen that the viscosity of the polyetherimide increases with the addition of the colorants. More specifically, at 365° C. the unfilled polyetherimide sample, Ultem 1010, comprised a viscosity of about 471 Pa·s, and the viscosity of the white polyetherimide composition, Sample 4, comprised about 514 Pa·s at a shear rate of 1,000 1/s.

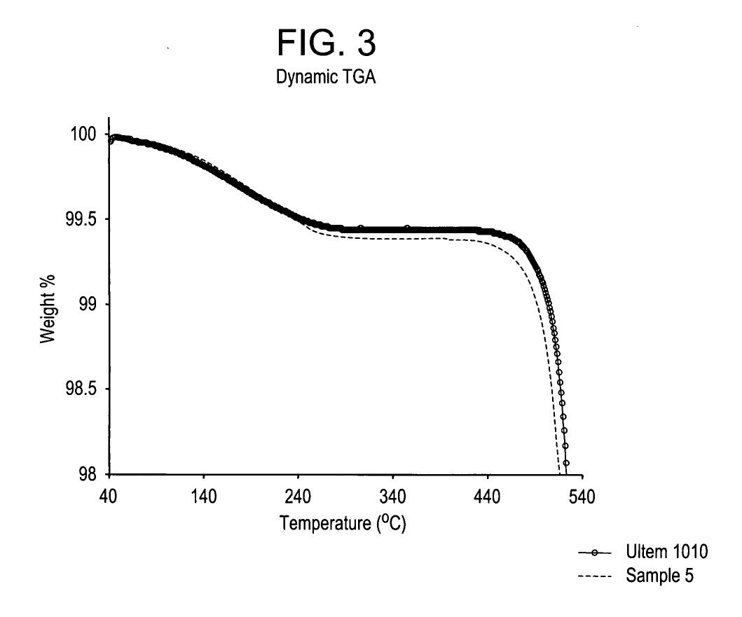

In addition to the rheological measurements, thermal gravimetric analyses of Sample 4 and the unfilled (comprising no additives) polyetherimide base resin sample, “Ultem 1010”, in order to compare the weight loss profile of the two materials over a given temperature range. During this test, each samples weight is measured as temperature is increased per a predetermined program. The resulting graph enables the interpretation of the thermal properties of a polymer composition (e.g., thermal stability, adsorption, desorption, desolvation, sublimation, vaporization, decomposition, solids reactions). As can be seen in FIG. 3, Sample 4 and the Ultem 1010 sample behave in a similar fashion based on their respective inflection points and the magnitude of the weight loss over the temperature range. This related behavior implies that Sample 4 did not experience a reduction in thermal stability due to the addition of the titanium dioxide and the colorants.

Referring now to Table 2, multiple film configurations are presented with their respective visual attributes. Sample 6 is the 50 μm thick PVF film standard previously presented in Table 1. For Samples 8-11, the substrate layer composition were the same. Sample 7 comprised a 50 μm thick natural PEI film with a 20 μm thick titanium dioxide coating. Sample 8 is a single layer extruded film comprising the composition of Sample 5. Sample 9 is a 2-layer coextruded film using the composition of Sample 5 as the contrast layer(s) and Ultem® 1000B with 20 pph carbon black as the substrate layer. Samples 10 and 11 were 3 layer coextruded films using the composition of Sample 5 as the outer contrast layers and Ultem® 1000B with 20 pph carbon black as the middle substrate layer. It is noted that each contrast layer and each substrate layer can be formed from multiple layers. All of the films comprised a total thickness of about 50 micrometers (about 2 mils).

TABLE 2

| No. | Description | YI | WI | Br | LT(%) | LR¹ |
|---|---|---|---|---|---|---|
| 6 | PVF Standard | 7.1 | 71.1 | 72.8 | 3.3 | 1 |
| 7 | Coated PEI | 27.3 | 72.2 | 75.9 | 27.3 | — |
| | Sample | | | | | |
| 8 | Monolayer PEI | 5.9 | 71.3 | 74.2 | 8.70 | 1 |
| 9 | Two Layer PEI | 0.3 | 77.6 | 70.6 | 0.55 | 3/2 |
| | | | | | | (AA/B) |
| 10 | Three Layer PEI | −1.7 | 78.8 | 67.9 | 0.57 | 4.5/1/4.5 |
| | | | | | | (A/B/A) |
| 11 | Three Layer PEI | −3.2 | 80.9 | 67.1 | 0.62 | 2.7/1/2.7 |
| | | | | | | (A/B/A) |

¹LR = layer ratio, wherein “A” is the contrast layer and “B” is the substrate layer

As can be seen in Table 2 the PVF Standard exhibited a yellowness of 7.1, a whiteness of 71.1, a brightness of 72.8, and a light transmission of 3.3% (% total light transmission). This sample was considered the standard in visual properties due to commercial acceptance. All other samples were compared to it. First, a Coated PEI Sample (Sample 7) was compared to the PVF sample. The Coated PEI Sample exhibited a higher yellowness; 27.3 compared to 7.1, higher whiteness; 72.2 compared to 71.1, higher brightness; 75.9 and higher light transmission; 27.3% compared to 3.3%, respectively. From these results it can be determined that the yellowness and the light transmission of the Coated PEI Sample are undesirably high.

Next, a Monolayer PEI Sample was compared to the PVF Standard. It can be seen that the Monolayer PEI Sample (e.g., contrast layer only) exhibited a lower yellowness than the PVF Standard; 5.9 compared to 7.1, a higher whiteness; 71.3 compared to 71.1, and a higher brightness; 74.2 compared to 72.8. However, the light transmission properties of the Monolayer PEI Sample is less desirable than the PVF Standard, which exhibited a value of 8.70% compared to 3.3%, respectively.

Sample 9 is the first highly opaque film sample evaluated in Table 2. Comparing the visual properties of this two-layer opaque film (e.g., contrast layer and substrate layer) to the PVF Standard, it can be seen that that the yellowness of the Two Layer PEI sample is lower; 0.3 compared to 7.1, the whiteness is higher; 77.6 compared to 71.1, the brightness is lower; 70.6 compared to 72.8, and the light transmission is lower; 0.55% compared to 3.3%, respectively. From these results, it is evident the two layer sample exhibits properties which are more desirable in film applications than even the PVF Standard. (It is noted that, for multilayer films disclosed herein (e.g., films comprising a substrate layer), WI, YI, brightness, and LT %, were measured from the contrast layer side of the film.)

With the contrast layer comprising a virgin plastic, white pigment, and non-white colorant, and with the substrate layer comprising a plastic and an opaque filler, the yellowness of the film (particularly of the contrast layer) can unexpectedly be reduced, at the same overall film thickness. As is shown in relation to Samples 8 and 9, when the substrate layer was employed, the yellowness of the contrast layer decreased from 5.9 to 0.3. Hence, films can be produced comprising a contrast layer formed from a virgin plastic, a non-white colorant and a white pigment, wherein the label has a yellowness index of less than 5, or, more particularly, less than or equal to 3, or, even more particularly, less than or equal to 1. Additionally, this film can have a light transmission of less than 7, or, more particularly, less than or equal to 5, or, even more particularly, less than or equal to 3, and, even more particularly, less than or equal to 1.

Moreover, comparing Sample 10, which is a highly opaque film comprising three-layers, to the PVF Standard, it can be seen that that the yellowness of the Three Layer PEI sample is lower; −1.7 compared to 7.1, the whiteness is higher; 78.8 compared to 71.1, the brightness is lower; 67.9 compared to 72.8, and the light transmission is lower; 0.57% compared to 3.3%, respectively. From these results, it is evident the Three Layer PEI sample also exhibits more desirable properties than the PVF Standard.

Although the substrate layer and the contrast layer have specifically been discussed herein as comprising PEI, it is also envisioned that the substrate layer or the contrast layer(s) can comprise a polyetherimide resin blend, copolymer, composition, or the like, such as, polyetherimide-polycarbonate copolymer, polyetherimide-siloxane copolymer, and polyetherimide-polyphenyleneoxide copolymer. Furthermore, it is to be apparent that the essence of the disclosed is not limited by layer thickness, it is to be understood that the film samples produced, tested, and compared herein were produced at bout 50 micrometers (μm) for data consistency and comparison purposes only and can be of any thickness. For example, a two-layer highly opaque film can be constructed with equal layer thicknesses measuring 25 μm, 50 μm, or even 200 μm each. It is also to be apparent the films are not limited to uniform layer thicknesses, any non-equal layer thicknesses can be employed, such as; a film comprising a substrate layer of 25 μm configured with a contrast layer of 50 μm, or even a film sample comprising a substrate layer of 250 μm configured with a contrast layer comprising a thickness measuring 25 μm. In another embodiment a three-layer highly opaque film can be configured with equal layer thicknesses such as with two 25 μm contrast layers with a 25 μm substrate layer disposed therebetween. Or, a three-layer highly opaque film can be constructed with non-equal layer thicknesses such as a 25 μm contrast layer configured onto a 150 μm substrate layer and a 75 μm contrast layer disposed on the opposite side of the substrate layer.

It is yet further envisioned that the highly opaque films disclosed herein are not limited in configuration. Two and three-layer configurations have been specifically discussed, however, the essence of the art is not to be limited. In another embodiment, a five-layer design is envisioned comprising the configuration; CSCSC, wherein “C” represents a contrast layer and “S” represents a substrate layer. In another configuration it is envisioned the design can be a SCS configuration, or a SCSC configuration, or the like.

It is even yet further envisioned that the highly opaque films disclosed herein can comprise additional layers. Such as, but not limited to, adhesive layer(s), layer(s) added onto the contrast layer(s) to improve weatherability, printed layer(s) configured onto the contrast layer comprising printed information, decorating film(s), anti-counterfeiting hologram(s), and so forth, as well as combinations comprising at least one of the foregoing.

It is also envisioned the contrast layer can comprise one or more pigments, dyes, and the like, capable of producing a colored contrast layer. It is to be apparent that these materials can be combined in any manner and in any quantity to produce a desired color.

The highly opaque films disclosed herein can be utilized for application and can be manufactured, converted, or processed by any common method as well. Exemplary methods of production can comprise the simultaneous coextrusion of the highly opaque film through a film die or blown film die. In addition, it is also envisioned the layers can be produced separately and adhered to one another in a secondary process.

It is to be apparent that the bright white compositions disclosed herein can be used in any application and converted utilizing any polymer processing operation, such as, but not limited to, extrusion, co-extrusion, injection molding, gas-assisted injection molding, compression molding, blown film extrusion, extrusion blow molding, sheet extrusion, co-extruded sheet extrusion, melt casting, calendaring, coating, thermoforming, lamination, and so forth.

In one specific application, the films discussed herein can be employed as high temperature films, which can be used in many applications, such as, but not limited to, automotive and electronics applications, and the like. The films are envisioned in one embodiment as a monolayer substrate on which an adhesive can be applied. In another embodiment, it is further envisioned that the white polyetherimide films disclosed herein can be employed within a laminate comprising one or more additional layers configured on the printed side of the film to increase surface energy, increase weatherability, provide aesthetic properties, or the like. In these applications, the film can comprise a thickness of about 20 micrometers to about 200 micrometers, or more specifically about 30 micrometers to about 100 micrometers, and yet more specifically, from about 40 to about 60 micrometers. At these thicknesses, the visual properties of the films tested above can produce a film that possesses the desirable properties of high whiteness (WI), high brightness (Br), and low yellowness (YI) when compared to a PVF film. However, the film must also exhibit sufficient opacity (low light transmission) to provide sufficient “hiding ability” in such applications.

In addition to the visual properties the films retained desirable tear resistance. The tear resistance of the film varies between materials and manufacturers, however, for high temperature films a specification of greater or equal to 125 newtons per mm (N/mm) can be employed, as tested by ASTM method D1004-94a. Optionally, the surface energy of the film could be increased to about 35 dynes to about 72 dynes (water wet condition) utilizing methods such as, but not limited to, corona discharge, plasma treatment, and/or flame treatment processes, to enhance printability.

Although disposing a top coat onto a film to attain a desire opacity and whiteness (and yellowness index), can be useful, the coating generally has a thickness of about 10 μm or more. This coating adds significant cost to producing the films, and only achieved a light transmission of about 15% or higher at a 50 μm thick film.

As noted above and illustrated in Table 1, it has unexpectedly been discovered that non-white colorants, e.g., color, can be employed in a plastic composition to improve whiteness (e.g., reduce yellowness). It is believed that plastic that would otherwise have a YI of greater than 11 (initially, after processing, and/or after aging) can attain a YI of less than or equal to about 10. Additionally a multilayer film can be produced with a YI of less than or equal to about 5, or more specifically a YI of less than or equal to about 3, as measured from a contrast layer side of the film. The film can also have a light transmission of less than or equal to about 5, or, more specifically less than or equal to about 3, as measured from a contrast layer side of the film. These films comprise substrate layer(s) and contrast layer(s), and exhibit a synergistic effect between the substrate layer and the contrast layer such that the film exhibits a lower YI than the contrast layer without the substrate layer, and even an greater whiteness. The whiteness can increase greater than or equal to about 5%, and even greater than or equal to about 10%. For example, the film can have a whiteness of greater than or equal 73, or, more specifically, greater than or equal to about 75, or, even more specifically, greater than or equal to about 78, and, yet more specifically, greater than or equal to about 80, as measure from the contrast layer side of the film.

For example, polyetherimide comprises desirable mechanical and thermal properties however, due to its inherent amber color, bright white compositions have been previously unachievable. As has been discussed herein a white polyetherimide film has been developed that comprises these desirable attributes and provides high opacity, high whiteness index, and low yellowness index. Although applicable in many applications, this composition is especially useful for use in labeling films as bright white high temperature PEI films have been unachievable in the past without the addition of coatings and/or subsequent layer(s) of material.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A plastic film, comprising:
a substrate layer comprising a plastic and an opaque filler; and
a contrast layer comprising
a virgin plastic, wherein the virgin plastic has a plastic yellowness index of greater than 11;
a white pigment; and
a non-white colorant;
wherein the contrast layer has a whiteness index of greater than or equal to about 50, a contrast layer yellowness index of less than 10, and a brightness of greater than or equal to 50, as measured on a 3 mm thick color chip under D65 illuminant and 2 degree observer; and
wherein the film has a light transmission of less than or equal to about 10% as measured on a 50 μm thick film sample as meaured from the contrast layer side.

2. The film of claim 1, wherein the film is in the form of a label.

3. The film of claim 1, wherein the whiteness index is greater than or equal to about 60 and the brightness is greater than or equal to 60.

4. The film of claim 1, wherein a 3 mm color chip comprising the virgin plastic and the non-white colorant exhibits a reflectance of greater than or equal to about 15% at a wavelength of about 380 nm to about 580 nm.

5. The film of claim 1, wherein the plastic yellowness index is greater than or equal to about 15.

6. The film of claim 4, wherein the plastic yellowness index is greater than or equal to about 40.

7. The film of claim 1, wherein the plastic yellowness index is measured after thermal aging.

8. The film of claim 1, wherein the virgin plastic comprises a material selected from the group consisting of: polycarbonate, polyarylene ether, polyphenylene, polypolysulfone, aromatic polysulfide, polyacrylate, polyketone, a combination comprising at least one of the foregoing plastics, and a reaction product formed from a reaction with at least one of the foregoing plastics.

9. The film of claim 1, wherein the film has a film yellowness index of less than 5 measured from the contrast layer side.

10. The film of claim 8, wherein the film yellowness index is less than or equal to 3.

11. The film of claim 9, wherein the film yellowness index is less than or equal to 1.

12. The film of claim 1, wherein the light transmission is less than or equal to 5.

13. The film of claim 11, wherein the light transmission is less than or equal to 3.

14. The film of claim 12, wherein the light transmission is less than or equal to 1.

15. The film of claim 1, further comprising an adhesive layer disposed on a surface of the substrate layer opposite the contrast layer or on a side of the contrast layer opposite the substrate layer.

16. The film of claim 1, wherein the opaque filler is a material that is capable of being added to the plastic and formed into a film having a light transmission of less than 5% at a thickness of 50 μm, and at an opaque filler loading of less than or equal to about 50 pph.

17. A plastic film, comprising:
a substrate layer comprising a plastic and an opaque filler; and
a contrast layer comprising
a polyimide;
a white pigment; and
a non-white colorant;
wherein the contrast layer has a whiteness index of greater than or equal to about 60, a contrast layer yellowness index of less than or equal to about 15, and a brightness of greater than or equal to 60, as measured on a 3 mm thick color chip under D65 illuminant and 2 degree observer; and
wherein the film has a light transmission of less than or equal to about of less than or equal to 10% as measured on a 50 μm thick film sample.

18. The film of claim 17, wherein the whiteness index is greater than or equal to about 65, a contrast layer yellowness index of less than or equal to 5, and the brightness is greater than or equal to about 65.

19. The film of claim 17, wherein the film has a film yellowness index of less than 5 measured from the contrast layer side.

20. The film of claim 19, wherein the film yellowness index is less than or equal to 3.

21. The film of claim 20, wherein the film yellowness index is less than or equal to 1.

22. The film of claim 17, wherein the light transmission is less than or equal to 5.

23. The film of claim 22, wherein the light transmission is less than or equal to 3.

24. The film of claim 23, wherein the light transmission is less than or equal to 1.

25. The film of claim 17, wherein the polyimide comprises a material selected from the group consisting of polyetherimide, a combination comprising a plastic and polyetherimide, and reaction products formed from a reaction with polyetherimide.

26. The film of claim 17, wherein the opaque filler is a material that is capable of being added to the plastic and formed into a film having a light transmission of less than 5% at a thickness of 50 μm, and at an opaque filler loading of less than or equal to about 50 pph.

27. The film of claim 17, wherein the film is in the form of a label.
